(19) United States
(12) Patent Application Publication
(10) Pub. No.: US 2016/0065088 A1
(43) Pub. Date: Mar. 3, 2016

(54) PUSH PULL INVERTER

(71) Applicant: Shenzhen Wisepower Innovation Technology Co., Ltd, Shenzhen (CN)

(72) Inventor: Hao Li, Shenzhen (CN)

(21) Appl. No.: 14/835,746

(22) Filed: Aug. 26, 2015

(30) Foreign Application Priority Data
Aug. 28, 2014 (CN) 201410429604.8

(51) Int. Cl. H02M 7/5381; H02M 7/48

(52) U.S. Cl. CPC H02M 7/5381; H02M 7/48; H02M 2007/4815

(57) ABSTRACT

The present invention discloses a push pull inverter, which includes a DC source V_{DC}, inductors Lₐ and L_{b}, wherein the inductor Lₐ is connected with the inductor L_{b}, an anode of the DC source V_{DC} is connected to the inductors Lₐ and L_{b} through an inductor L_{d} and a resistor R_{d}, a voltage of a second end of the inductor Lₐ is loaded to a drain of a switching tube S₁, a voltage of a second end of the inductor L_{b} is loaded to a drain of a switching tube S₂, a source of the switching tube S₁ and a source of the switching tube S₂ are connected to a cathode of the DC source V_{DC}, and a resonant circuit is connected between the inductor Lₐ and the inductor L_{b}. The present invention decreases the current of the push pull inverter and increases the voltage by changing an operating frequency and injecting a drive signal.

### CROSS-REFERENCE TO RELATED APPLICATION

This present application claims the benefit of Chinese Patent Application No. 201410429604.8 filed on Aug. 28, 2014, the contents of which are hereby incorporated by reference.

### BACKGROUND

1. Technical Field

The present invention relates to a push pull inverter, and particularly, to a push pull inverter which decreases the current of the push pull inverter and increases the voltage by changing an operating frequency and injecting a drive signal.

2. Related Art

At present, a push pull resonant inverter is one of the most popular power inverters in low to medium power wireless power transfer applications due to its simplicity and high power efficiency. However, to transfer power to one or more loosely coupled wireless loads, the input voltage of the push pull inverter is normally required to be high to achieve effective transmission of the power of the push pull inverter.

### SUMMARY

The technical problem to be solved by the present invention is to provide a push pull inverter which decreases the current of the push pull inverter and increases the voltage by changing an operating frequency and injecting a drive signal.

To solve the above technical problem, the present invention adopts the following technical solution.

A push pull inverter, including a DC source V_{DC}, an inductor Lₐ and an inductor L_{b}, wherein a first end of the inductor Lₐ is connected with a first end of the inductor L_{b}, an anode of the DC source V_{DC} is connected to the first ends of the inductor Lₐ and the inductor L_{b} through an inductor L_{d} and a resistor R_{d} sequentially connected in series, a voltage of a second end of the inductor Lₐ is loaded to a drain of a switching tube S₁, a voltage of a second end of the inductor L_{b} is loaded to a drain of a switching tube S₂, a source of the switching tube S₁ and a source of the switching tube S₂ are connected to a cathode of the DC source V_{DC}, two signals which are at the same frequency but opposite in phase are respectively connected to a gate of the switching tube S₁ and a gate of the switching tube S₂, and a resonant circuit is connected between the second end of the inductor Lₐ and the second end of the inductor L_{b}.

Preferably, the resonant circuit is a parallel resonant circuit.

Preferably, the resonant circuit includes a capacitor C₁, an inductor L₁ and a resistor R₁, two ends of the capacitor C₁ are respectively connected with the second end of the inductor Lₐ and the second end of the inductor L_{b}, and the inductor L₁ is connected in series to the resistor R₁ and then connected in parallel to the capacitor C₁.

Preferably, the push pull inverter further includes a diode D₁, an anode of the diode D₁ being connected with the second end of the inductor Lₐ, and a cathode of the diode D₁ being connected with the drain of the switching tube S₁.

Preferably, the push pull inverter further includes a diode D₂, an anode of the diode D₂ being connected with the second end of the inductor L_{b}, and a cathode of the diode D₂ being connected with the drain of the switching tube S₂.

Preferably, a frequency generated by the resonant circuit is odd times of switching frequencies generated by the switching tube S₁ and the switching tube S₂.

In the push pull inverter disclosed in the present invention, the inductor Lₐ and the inductor L_{b} are connected in series to each other and then are connected in parallel to the resonant circuit, and the switching tube S₁ and the switching tube S₂ are respectively driven through two low-frequency drive signals which are at the same frequency but opposite in phase, thereby decreasing the current and increasing the voltage of the push pull inverter, to cause the push pull inverter to have a better power transfer capability. The present invention, based on a new topology and control method, can achieve a boost operation of the push pull inverter and can achieve soft switching at the same time.

### BRIEF DESCRIPTION OF THE DRAWINGS

FIG. 1 is a schematic circuit diagram of a push pull inverter according to an embodiment of the present invention;

FIG. 2 is a waveform of signals output by a push pull inverter when an actual switching frequency and a ZVS switching frequency are the same according to an embodiment of the present invention;

FIG. 3 is a waveform of signals output by a push pull inverter when an actual switching frequency is ⅓ of a ZVS switching frequency according to an embodiment of the present invention;

FIG. 4 is equivalent circuit when S₁ is on, S₂ is off;

FIG. 5 is equivalent circuit when S² is on, S₁ is off;

FIG. 6 is voltage and current waveforms of ZVS points of the stroboscopic map;

FIG. 7(a) is voltage and current waveforms of at 1^{st} ZVS point;

FIG. 7(b) is the voltage and track current using numerical calculations at steady state over an entire operating period of at 1^{st} ZVS point;

FIG. 8(a) is voltage and current waveforms of at the 2^{nd} ZVS point;

FIG. 8(b) is the voltage and track current using numerical calculations at steady state over an entire operating period of at 2^{nd} ZVS point;

FIG. 9(a) is voltage and current waveforms of at 3^{rd} ZVS point;

FIG. 9(b) is the voltage and track current using numerical calculations at steady state over an entire operating period of at 3^{rd} ZVS point;

FIG. 10(a) is voltage and current waveforms of at the 4^{th} ZVS point;

FIG. 10(b) is the voltage and track current using numerical calculations at steady state over an entire operating period of at 4^{th} ZVS point;

FIG. 11 is step current injection model at ZVS points;

FIG. 12(a) is PLECS model of the push pull inverter;

FIG. 12(b) is the diagram of the push pull inverter;

FIG. 13 is simulation results of the selected odd ZVS points;

FIG. 14 is FFT analysis of track current at the 3^{rd} ZVS point;

FIG. 15 is FFT analysis of track current at the 5^{th} ZVS point;

FIG. 16 is steady state waveforms under 1^{st} ZVS operation point;

FIG. 17 is steady state waveforms under the 3^{rd} ZVS operation point; and

FIG. 18 is steady state waveforms under the 5^{th} ZVS operation point.

### DETAILED DESCRIPTION

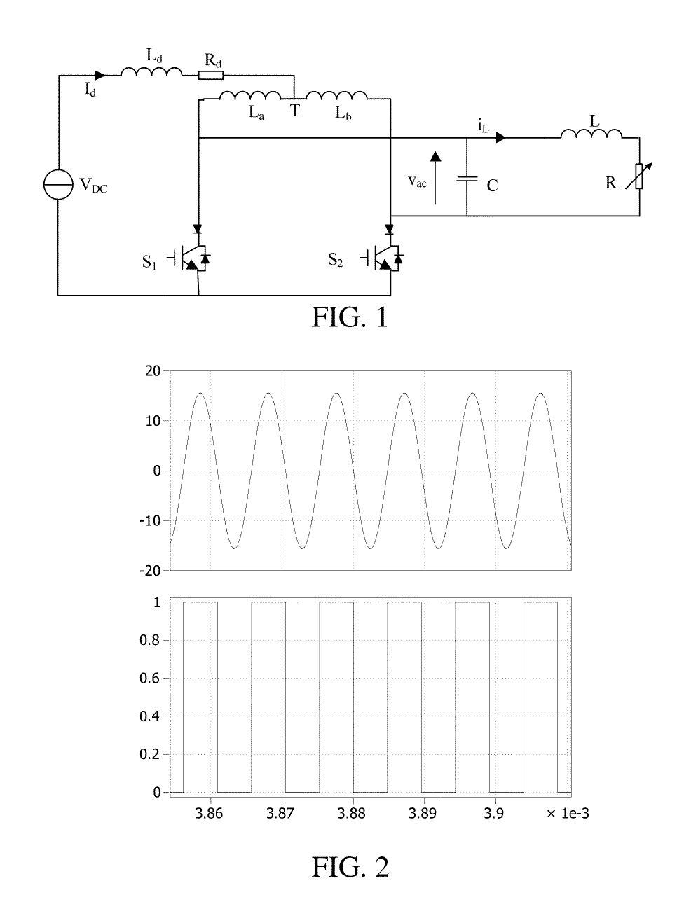

The present invention discloses a push pull inverter, as shown in FIG. 1, which includes a DC source V_{DC}, an inductor Lₐ and an inductor L_{b}, wherein a first end of the inductor Lₐ is connected with a first end of the inductor L_{b}, an anode of the DC source V_{DC} is connected to the first ends of the inductor Lₐ and the inductor L_{b} through an inductor L_{d} and a resistor R_{d} sequentially connected in series, a voltage of a second end of the inductor Lₐ is loaded to a drain of a switching tube S₁, a voltage of a second end of the inductor L_{b} is loaded to a drain of a switching tube S₂, a source of the switching tube S₁ and a source of the switching tube S₂ are connected to a cathode of the DC source V_{DC}, two signals which are at the same frequency but opposite in phase are respectively connected to a gate of the switching tube S₁ and a gate of the switching tube S₂, and a resonant circuit (10) is connected between the second end of the inductor Lₐ and the second end of the inductor 4. The inductor Lₐ and the inductor L_{b} are connected in series to each other and then are connected in parallel to the resonant circuit 10, and the switching tube S₁ and the switching tube S₂ are respectively driven through two low-frequency drive signals which are at the same frequency but opposite in phase, thereby decreasing the current of the push pull inverter and increasing the voltage, to cause the push pull inverter to have a better power transfer capability.

In one embodiment of the push pull inverter, referring to FIG. 1, on the basis of the previous technical solution, specifically, the resonant circuit 10 is a parallel resonant circuit. The resonant circuit (10) includes a capacitor C₁, an inductor L₁ and a resistor R₁, two ends of the capacitor C₁ are respectively connected with the second end of the inductor Lₐ and the second end of the inductor L_{b}, and the inductor L₁ is connected in series to the resistor R₁ and then connected in parallel to the capacitor C₁.

To prevent the capacitor C₁ from being short-circuited, the push pull inverter further includes a diode D₁ and a diode D₂, an anode of the diode D₁ is connected with the second end of the inductor Lₐ, and a cathode of the diode D₁ is connected with the drain of the switching tube S₁; an anode of the diode D₂ is connected with the second end of the inductor L_{b}, and a cathode of the diode D₂ is connected with the drain of the switching tube S₂. The present invention prevents the resonant capacitor C₁ from being short-circuited through the diodes blocked in two directions, thereby achieving a zero-voltage operation.

In the push pull inverter disclosed in the present invention, the push pull inverter operates at a Zero Voltage Switch (ZVS) frequency, where S₁ and S₂ are switched on and off at the zero voltage crossings of VAC to drive the resonant tank. Therefore, the switches are essentially switched at 50% duty cycle. Under such an operation, the push pull resonant inverter produces nearly sinusoidal voltage and current in the coil. Thus the switching losses are essentially eliminated, and a better waveform with low EMI is achieved.

Due to the high frequency operation, a push pull topology act as a quasi-current source inverter by alternating the conduction of the switch pairs. If each switch operates for a longer period than the resonant frequency, the current into the parallel resonant tank will be increased. For such a reason, if two switches are operated at a lower variable switching frequency than the fundamental ZVS resonant voltage, the output voltage can be boosted by following the relationship:

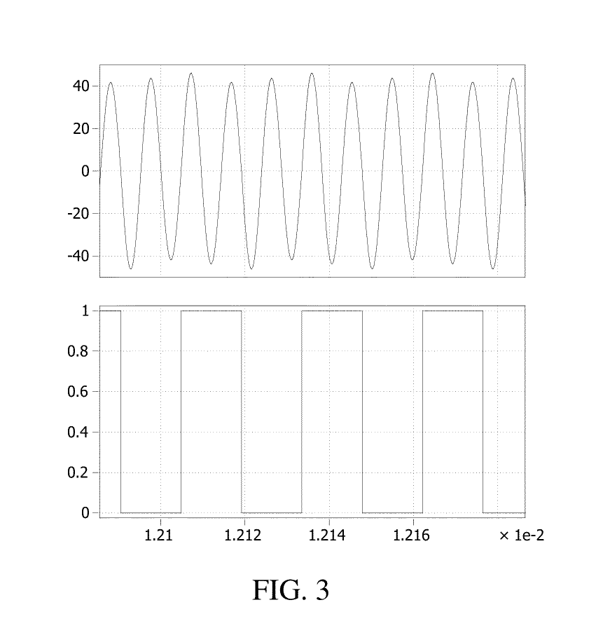

Here, fs is the actual switching frequency, and f1 is the ZVS switching frequency. Under such an operation, the resonant voltage will become higher. FIG. 2 illustrates a waveform of signals output by the push pull inverter when the actual switching frequency fs and the ZVS switching frequency f1 are the same, and FIG. 3 illustrates a waveform of signals output by the push pull inverter when the actual switching frequency fs is ⅓ of the ZVS switching frequency f1. In a normal node, if the conduction frequency of each switches is lower than the fundamental ZVS frequency f1 (which is about ⅓ of F1 in the example figure), the resonant voltage is increased by about three times. In fact, in addition to the fundamental ZVS frequency f1, there may be multiple ZVS frequencies existing which can lead to different boosting features. Using this principle, a push pull inverter can be designed to have a higher power transfer capability by operating at lower ZVS frequencies. Likewise, the push pull inverter operates at an odd number of frequency switching points of each resonant frequency. Using this principle, a push pull inverter can be designed to have a higher power transfer capability by operating at lower ZVS frequencies. To understand whether more ZVS frequencies exist and where they are, as well as how the ZVS frequencies affect the inverter performance, detailed analysis is undertaken in the following section.

System Modeling and Analysis

As discussed, running a push pull inverter at a lower switching frequency than the fundamental ZVS frequency can boost the resonant voltage. In addition, enabling a better performance and a reduction in the switching losses and EMI, it is desirable to operate the push pull inverter at these low frequency ZVS points. However, even when multiple ZVS frequencies may exist for a high order push pull inverter, it does not mean all the ZVS frequency points are suitable for a boost operation without affecting the overall performance. In order to understand the exact ZVS operating frequencies and how this operation affects the output performance, a stroboscope mapping model method is used to analyse the ZVS frequencies of a push pull inverter. Unlike the traditional AC impedance analysis method, which is more suitable for a sinusoidal linear circuit, the stroboscopic mapping method is a numerical method for accurate nonlinear switching circuit analysis. It treats the switching period as a variable and can be used to find all possible steady state ZVS frequencies of a switch-mode converter.

Stroboscopic Mapping Model

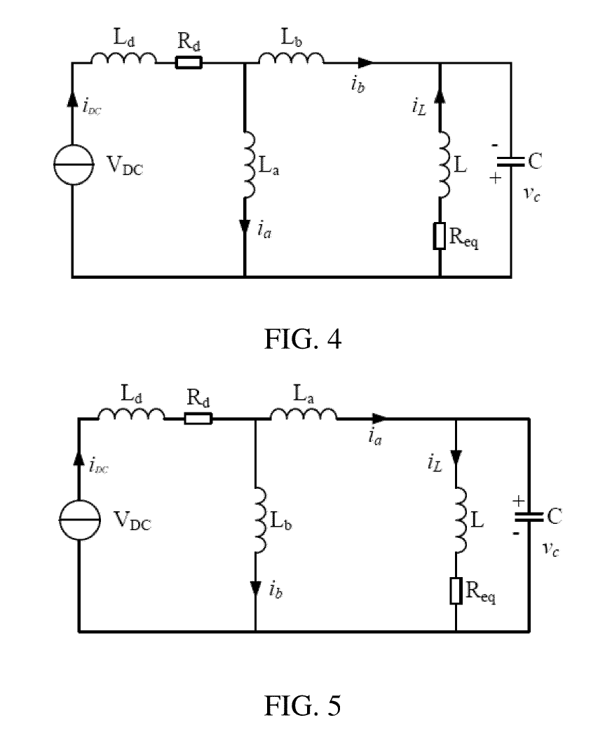

In order to ensure soft switching operation of a push pull inverter shown in boost mode, switches S1 and S2 must operate alternately at the zero instants of the resonant voltage of the tuning capacitor. Each of the switches operates during half of the overall period of Ts under steady state condition. The equivalent circuit model of each operational state of the push pull inverter, where either (S1 on/S2 off) or (S2 on/S1 off), is shown in FIG. 4. and FIG. 5 respectively. Here the split windings of the transformer are modeled as uncoupled inductors. Selecting the currents and capacitor voltages in each equivalent circuit as state variables, the state space equations of the system can be obtained for each operation.

From the equivalent model above, when S₁ is on, S₂ is off, the differential equation can be expressed as:

$$\{ \begin{matrix}\frac{d {i}_{a}}{d t} = \frac{{L}_{b} {V}_{D C} - {R}_{d} {L}_{b} {i}_{a} - {R}_{d} {L}_{b} {i}_{b} - {L}_{d} {v}_{c}}{{L}_{b} ( {L}_{d} + {L}_{a} ) + {L}_{a} {L}_{d}} \\ \frac{d {i}_{b}}{d t} = \frac{{L}_{a} {V}_{D C} - {R}_{d} {L}_{a} {i}_{a} - {R}_{d} {L}_{a} {i}_{b} + ( {L}_{d} + {L}_{a} ) {v}_{c}}{{L}_{b} ( {L}_{d} + {L}_{a} ) + {L}_{a} {L}_{d}} \\ \frac{d {v}_{c}}{d t} = - \frac{1}{C} ( {i}_{b} + {i}_{L} ) \\ \frac{d {i}_{L}}{d t} = - \frac{1}{L} ( {v}_{c} - {R}_{eq} {i}_{L} )\end{matrix} \qquad ( 7 \text{-} 2 )$$

Similarly, when S₂ is on, S₁ is off, the differential equation can be expressed as:

$$\{ \begin{matrix}\frac{d {i}_{a}}{d t} = \frac{{L}_{b} {V}_{D C} - {R}_{d} {L}_{b} {i}_{a} - {R}_{d} {L}_{b} {i}_{b} - ( {L}_{d} + {L}_{b} ) {v}_{c}}{{L}_{a} ( {L}_{d} + {L}_{b} ) + {L}_{b} {L}_{d}} \\ \frac{d {i}_{b}}{d t} = \frac{{L}_{a} {V}_{D C} - {R}_{d} {L}_{a} {i}_{a} - {R}_{d} {L}_{a} {i}_{b} + {L}_{d} {v}_{c}}{{L}_{a} ( {L}_{d} + {L}_{b} ) + {L}_{b} {L}_{d}} \\ \frac{d {v}_{c}}{d t} = \frac{1}{C} ( {i}_{a} - {i}_{L} ) \\ \frac{d {i}_{L}}{d T} = - \frac{1}{L} ( {v}_{c} - {R}_{eq} {i}_{L} )\end{matrix} \qquad ( 7 \text{-} 3 )$$

Let x=[iₐ,i_{b},v_{c},iₚ]^{T} and v=[V_{DC}] be the state vector and the input vector respectively. The system can be described by the following state space model.

$$\begin{matrix}\dot{x} = Ax + Bv \\ A = A 1 , if S 1 is on and S 2 off . & ( 7 \text{-} 4 ) \\ A = {A}_{1} = [ \begin{matrix}- \frac{{R}_{d} {L}_{b}}{{Δ}_{a}} & - \frac{{R}_{d} {L}_{d}}{{Δ}_{a}} & - \frac{{L}_{d}}{{Δ}_{a}} & 0 \\ - \frac{{R}_{d} {L}_{a}}{{Δ}_{a}} & - \frac{{R}_{d} {L}_{a}}{{Δ}_{a}} & \frac{( {L}_{d} + {L}_{b} )}{{Δ}_{a}} & 0 \\ 0 & - \frac{1}{C} & 0 & - \frac{1}{C} \\ 0 & 0 & - \frac{1}{L} & - \frac{{R}_{eq}}{L}\end{matrix} ] , & \\ B = {B}_{1} = [ \begin{matrix}\frac{{L}_{b}}{{Δ}_{a}} \\ \frac{{L}_{a}}{{Δ}_{a}} \\ 0 \\ 0\end{matrix} ] & \\ {Δ}_{a} = {L}_{b} ( {L}_{D C} + {L}_{a} ) + {L}_{a } {L}_{D C} \\ A = A 2 , if S 2 is on , and S 1 off . & \\ A = {A}_{2} = [ \begin{matrix}- \frac{{R}_{d} {L}_{b}}{{Δ}_{b}} & - \frac{{R}_{d} {L}_{b}}{{Δ}_{b}} & - \frac{( {L}_{d} + {L}_{b} )}{{Δ}_{b}} & 0 \\ - \frac{{R}_{d} {L}_{a}}{{Δ}_{b}} & - \frac{{R}_{d} {L}_{a}}{{Δ}_{b }} & \frac{{L}_{d}}{{Δ}_{b}} & 0 \\ \frac{1}{C} & 0 & 0 & - \frac{1}{C} \\ 0 & 0 & - \frac{1}{{L}_{p}} & \frac{{R}_{eq}}{{L}_{p}}\end{matrix} ] , & \\ B = {B}_{2} = [ \begin{matrix}\frac{{L}_{b}}{{Δ}_{b}} \\ \frac{{L}_{a}}{{Δ}_{b}} \\ 0 \\ 0\end{matrix} ] \\ {Δ}_{b} = {L}_{a} ( {L}_{D C} + {L}_{b} ) + {L}_{b} {L}_{D C} & \end{matrix}$$

Since the system matrix (A) is invertible, and the input voltage V_{DC} is a constant in each half operation period, the solution for each operation state can therefore be described as follows.

x(t)=e^{At}x₀+(e^{At}−1)A⁻¹Bv (7-5)

Here x0 is the initial value, and the identity matrix (I) is of the same size as the system matrix (A). Due to the alternating switching conduction repeating at steady state, xₙ could be defined as the initial value of the current state of the n^{th} switching period T, which is also the final value of the last state. Similarly, xₙ₊₁ could to be defined as the final value of the current state, which is also the initial value at the next period. As such, the iteration equation of the states of (n+1)^{th} period, therefore, can be expressed generally as:

$${x}_{n + 1} = {e}^{AT} {x}_{n} + {( {e}^{A \frac{T}{2}} - I )}^{2} {A}^{- 1} {BV}_{d c} \qquad ( 7 \text{-} 6 )$$

Because the actual waveforms of each operation repeat at steady state, the state vector repeats periodically, which leads to a fixed point x*=Xₙ₊₁=Xₙ. By the definition of

$${e}^{A \frac{1}{2}} = Φ ( \frac{T}{2} ) ,$$

then according to equation (7-6), all of the fixed operation points of the system can be obtained by:

$${x}^{*} = {( I - {Φ}_{2} ( \frac{T}{2} ) {Φ}_{1} ( \frac{T}{2} ) )}^{- 1} ( \begin{matrix}{Φ}_{2} ( \frac{T}{2} ) ( {Φ}_{1} ( \frac{T}{2} ) - I ) {A}_{1}^{- 1} {B}_{1} {V}_{d c} + \\ ( {Φ}_{1} ( \frac{T}{2} ) - I ) {A}_{2}^{- 1} {B}_{2} {V}_{d c}\end{matrix} ) \qquad ( 7 \text{-} 7 )$$

The resonant voltage and the track current at all the possible switching instants can be described as follows.

fᵥ_{_{c}}(T)=Yx* (7-8)

fᵢ_{_{L}}(T)=Zx* (7-9)

where Y=[0 0 1 0] and Z=[0 0 0 1] are the selection matrices of the capacitor voltage v_{c}(t) and the track current i_{L}(t) respectively. In order to obtain the ZVS points, the resonant voltage must be zero at the switching instants. This means the resonant voltage of the model at fixed operating periods has to satisfy the boundary condition as following: where for the first half cycle:

$${H}_{1} ( \frac{T}{2} , {x}^{*} ) = {Y ( {Φ}_{1} ( \frac{T}{2} ) {x}^{*} + ( {Φ}_{1} ( \frac{T}{2} ) - I ) {A}_{1}^{- 1} {B}_{1} {V}_{d c} )}^{- 1} = 0 \qquad ( 7 \text{-} 10 )$$

And for the second half cycle;

$${H}_{2} ( \frac{T}{2} , \frac{T}{2} , {x}^{*} ) = {Yx}^{*} = 0 \qquad ( 7 \text{-} 11 )$$

Determination of Multiple ZVS Periods

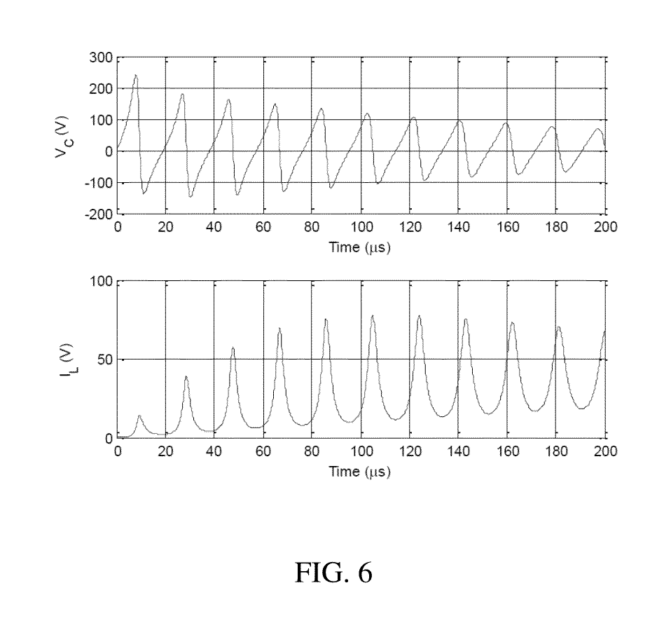

From the above stroboscopic mapping method, once the capacitor voltage reaches the boundary condition, it means that the switches are operating at a zero crossing condition. Accordingly, all of the obtained values of TS are the possible ZVS periods of the push pull inverter. Based on such a mapping method, the voltage and the associated current at the different switching instants can also be obtained. FIG. 6 shows the capacitor voltage and the track current of the stroboscopic mapping model of a given push pull inverter at different operation periods which are calculated by equations (7-8) and (7-9). The detailed parameters of the push pull inverter are listed in Tablet. The Matlab code for the calculation of the ZVS periods can be found in the Appendices. As can be seen from the figure, the ZVS periods are the points where the capacitor voltage is equal to zero. It has been found that there are more than one ZVS points for the push pull inverter. If the push pull inverter is operated at these ZVS periods, the inverter will be fully soft switched and leads to different voltages and track currents.

TABLE 1
Component parameters of push pull inverter

| Notes | Parameters | Values | |
|---|---|---|---|
| Input DC voltage | V_{DC} | 10 | V |
| DC inductor | L_{d} | 1 | mH |
| Splitting transformer | Lₐ | 1 | mH |
| Splitting transformer | L_{b} | 1 | mH |
| Primary resonant capacitor | C | 0.67 | μF |
| Primary resonant inductor | L | 3.45 | μH |
| ESR of track | R_{ESR} | 0.012 | Ω |
| Total Equivalent load | R | 0.06 | Ω |

To clearly find these ZVS points and their relationship, the first nine of the ZVS periods and frequencies are listed in Table 2.

TABLE 2
Calculated value of first nine ZVS operation points

| ZVS | | | | | | | | | |
|---|---|---|---|---|---|---|---|---|---|
| Points | 1 | 2 | 3 | 4 | 5 | 6 | 7 | 8 | 9 |
| T_{z} (μs) | 9.60 | 19.1 | 28.7 | 38.2 | 47.8 | 57.3 | 66.9 | 76.4 | 86.0 |
| f_{z} (kHz) | 104.17 | 52.36 | 34.84 | 26.18 | 20.92 | 17.45 | 14.95 | 13.09 | 11.63 |

The first ZVS point is at 9.60 μs, which is close to the free oscillation period 9.55 μs. As can be seen in FIG. 6, the track current at the first ZVS point is nearly located at the first peak. This implies that if the resonant voltage of the capacitor is equal to zero, the resonant track current is nearly at its resonant peak due to the approximate 90 degrees phase angle delay. However, at the second ZVS point, which is about 19.1 μs in FIG. 6, it can be observed that the voltage is at zero but the corresponding track current at this instant is lower. It is difficult to determine the relationship between the resonant voltage and the track current at the 2^{nd} and other even number operation points.

Waveforms

As shown in Table 2, the operation frequencies are nearly an integral multiple of the fundamental frequencies. After given the exact ZVS operation points, the steady state waveforms of the inverter output voltage and current can be obtained to understand how these ZVS operation points affect the resonant voltage and the resultant track current.

Due to the symmetrical operation of two switches, once the ZVS points are calculated by equation (7-7), the waveforms obtained during half period operation can be obtained. The resonant voltage waveform is identical for both half cycles at steady state. Therefore, the waveform obtained before reaching the first boundary condition defined by equation (7-10) can present the actual current at steady state. The resonant voltage and the track current can be expressed respectively as:

$$\begin{matrix}{V}_{{C\_H}_{1}} ( t ) = {Y ( {Φ}_{1} ( \frac{t}{2} ) {x}^{*} + ( {Φ}_{1} ( \frac{t}{2} ) - I ) {A}_{1}^{- 1} {B}_{1} {V}_{d c} )}^{- 1} = 0 & ( 7 \text{-} 12 ) \\ {i}_{{L\_H}_{1}} ( t ) = {Z ( {Φ}_{1} ( \frac{t}{2} ) {x}^{*} + ( {Φ}_{1} ( \frac{t}{2} ) - I ) {A}_{1}^{- 1} {B}_{1} {V}_{d c} )}^{- 1} = 0 & ( 7 \text{-} 13 )\end{matrix}$$

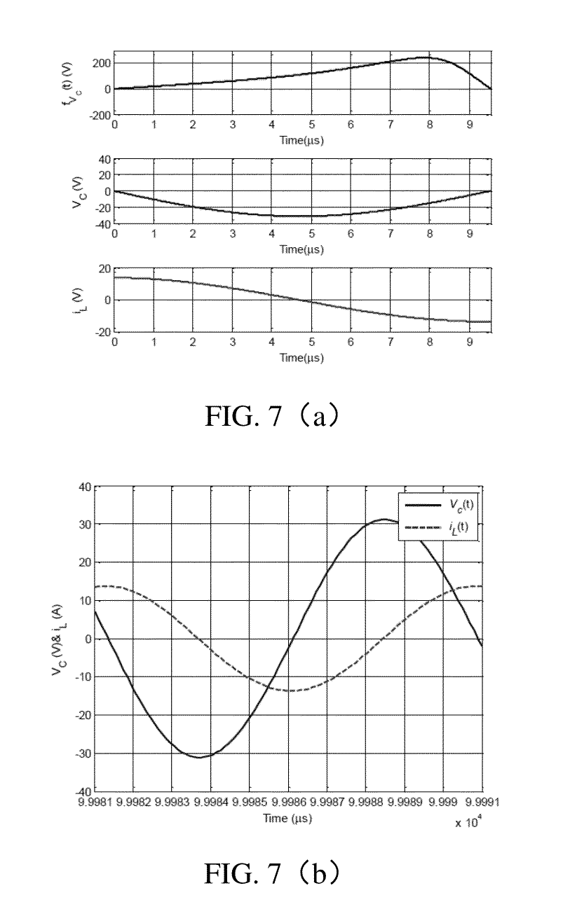

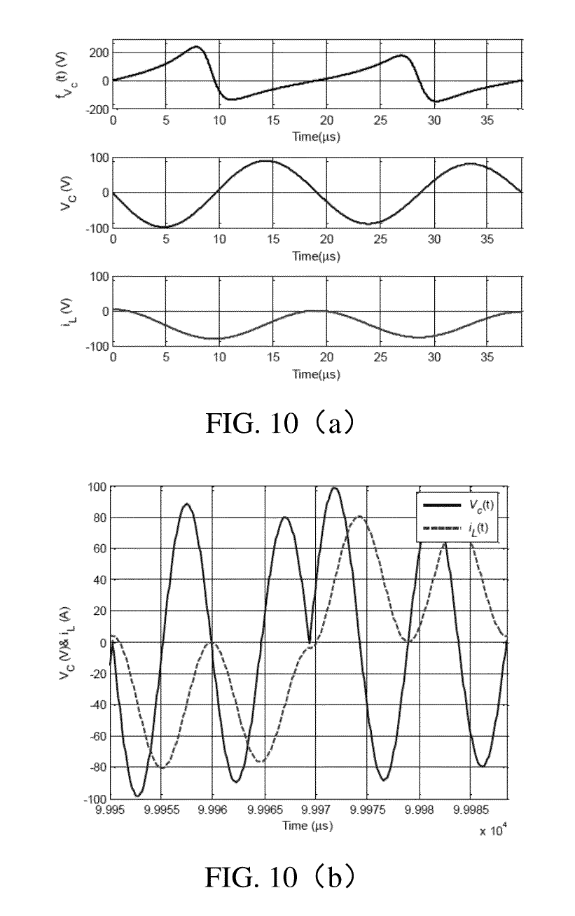

FIG. 7(a)-FIG. 10(a) show the half period waveform of the mapping model from equation (7-12) and (7-13), which are the first four operation points including both odd and even ZVS points. In fact, here the time span doubles for easy comparison with the zero crossings of fᵥ_{_{c}}(t). This means the magnitude of the actual voltage and current waveforms could decay by half over this time. The waveforms of the second half period repeat in the opposite direction.

To understand the relationship between the half period and full period waveforms easily, a steady state waveform also can be obtained by numerical calculation once the operation frequencies are obtained in Table 2. FIG. 7(b)-FIG. 10(b) show the voltage and track current using numerical calculations at steady state over an entire operating period.

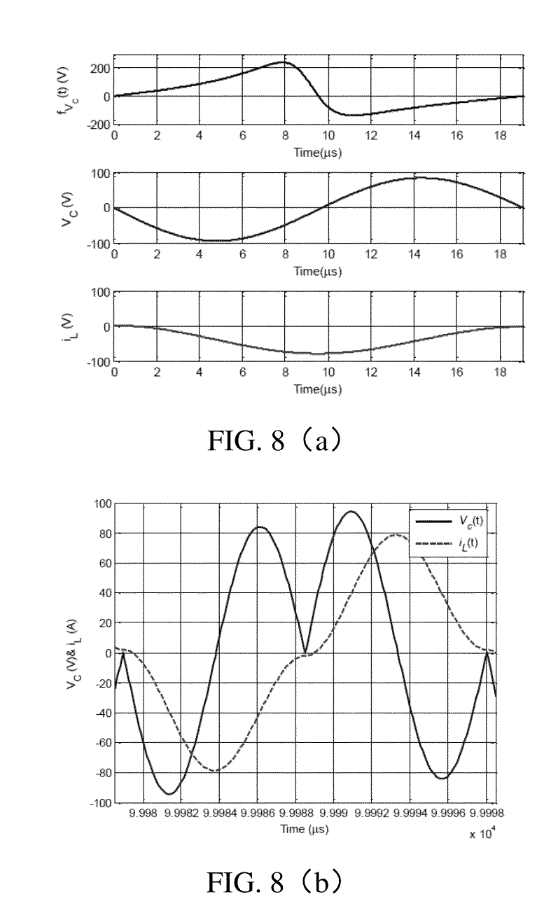

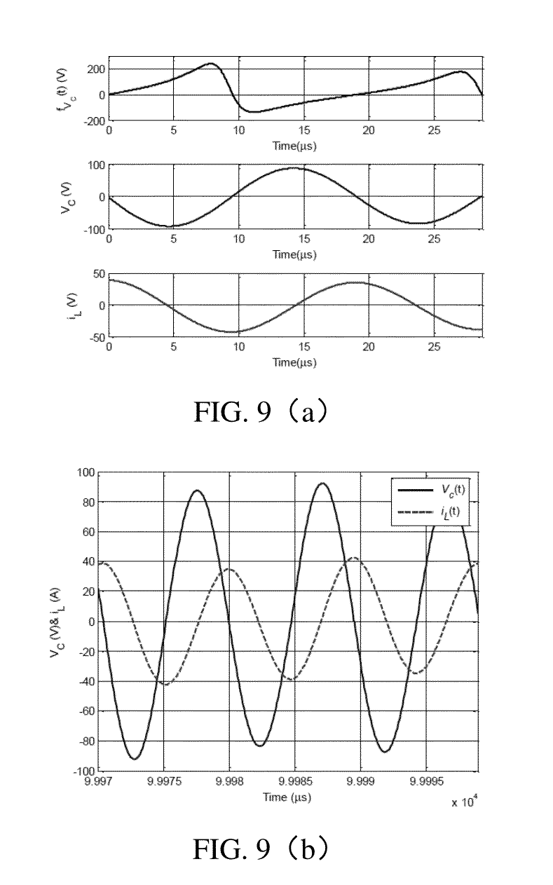

It can be seen from FIG. 7(a) that the voltage waveform is nearly a half sine wave from equation (7-12), if the inverter is operated at the fundamental ZVS point. After repeating this operation over the second half of the waveform as shown FIG. 7(b), it can be clearly seen that the voltage waveform is nearly completely sinusoidal. The track current waveform is also nearly sinusoidal with about 90 degrees phase delay. At the 2^{nd} ZVS operation point shown in FIG. 8(a), it can be seen that, the peak value of the resonant voltage is boosted to about 100V which is nearly three times that of the first ZVS point. The resonant voltage over the half period is nearly sine wave but it is heavily distorted over a full period, resulting in a poor current waveform. The current at the secondary ZVS operation point is also boosted to nearly to 80 A. The waveform of an entire period in FIG. 8(b) however is not smooth. There are two continuous half positive or negative cycles in the voltage waveform at steady state. In addition, the current waveform is not sinusoidal at all and includes obvious harmonic distortion. When the push pull inverter works at the 3^{rd} ZVS operation point, the voltage draws a smooth and nearly sinusoidal waveform again as shown in FIG. 9(b), The current waveform also becomes much better compared to the 2^{nd} ZVS point. Although the magnitude of the capacitor voltage and the track current at the third operation point drops compared with the 2^{nd} operation point, both of them are almost boosted by almost three times over normal operation compared to the fundamental ZVS point. But it also can be observed from FIG. 9(a) and FIG. 9(b), that a small fluctuation arises in both the voltage and current when working at this 3^{rd} operation point. FIGS. 8(a)-10(b) shows that if the inverter is operated at the 4^{th} operation point, the operation frequency at this ZVS point is about ¼ of the ZVS switching frequency of the fundamental ZVS point. As expected from the earlier results, two parallel positive or negative half cycle appear on both the voltage and current waveforms. The quality of the waveforms under this 4^{th} operation point is very poor and not acceptable.

Further investigation shows that the resonant voltage waveforms of all even ZVS operation points are heavily distorted. In contrast, the resonant voltage waveforms of all odd ZVS operation points are smooth with less distortion. The amplitude of the voltage increases with the decrease of ZVS frequency. Good current waveforms are also obtained at odd ZVS operation points because the energy injection direction is consistent with the trend of the voltage oscillation. Such a phenomenon offers a good basis for designing a push pull inverter with a high power transfer capability without an additional boost stage to increase the DC input voltage.

Each of the odd operation points can be accurately obtained by the numerical solutions of the stroboscopic mapping method. But for a system with a high Q, the operation frequency can be approximated as follows:

$${f}_{S} \approx \frac{1}{2 n + 1} {f}_{1} n = 1 , 2 , 3 \qquad ( 7 \text{-} 14 )$$

Here f1 is the first ZVS frequency, which is nearly equal to f₁=½π\sqrt{LC} if Q is high.

Multiple ZVS Operation Points Conditions

According to the above stroboscopic mapping model, the numerical solutions of the multiple ZVS operation points can be obtained for a given push pull inverter. The drawback of the stroboscopic model is that the numerical solution does not predict the conditions which can ensure a proper ZVS points for boost operation. In fact, the existence of the multiple ZVS points is determined by the circuit parameters, e.g. the quality factor of the resonant circuit. By looking at the structure of the push pull inverter in FIG. 1, the DC inductor and the phase splitting transformer are mainly required to form a quasi-current source by alternating the switching operation of S1 and S2. In practice, they are normally designed to be much larger than the track resonant inductance. The large DC inductance and high frequency operation make the input current almost constant, so a fifth order push pull inverter could be simplified to a parallel tuned circuit excited by a current source.

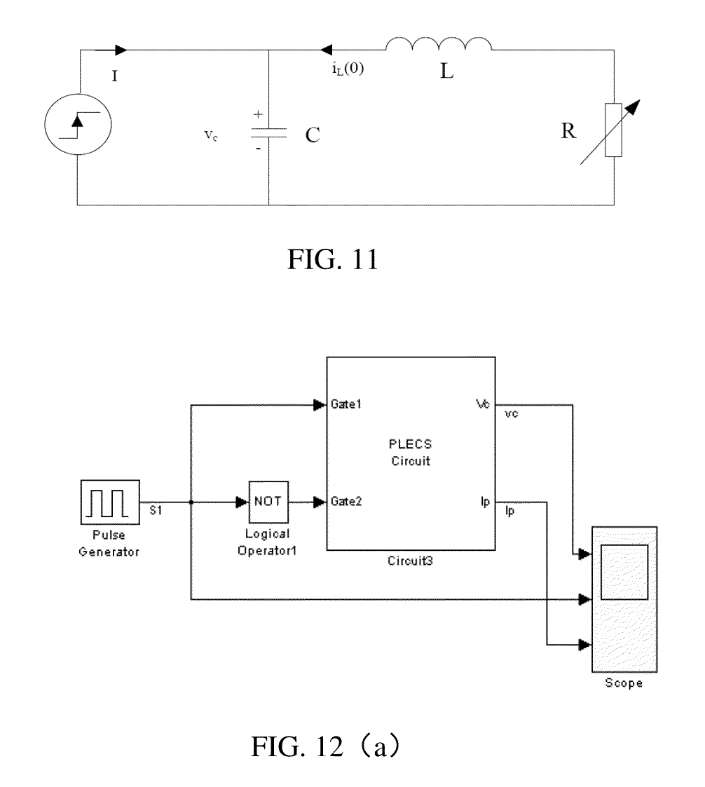

Because the switches conduct alternately, the end of a particular switching period can be treated as the initial condition for the start of the next switching period. In addition, these conditions must last for an entire half switching period. The input of the push pull resonant inverter can be regarded as a step-input current source at each switching period. FIG. 11 shows a model of the inverter exited by a step current injection at the switching instant of the ZVS points. Based on such a model, an approximated analysis can be conducted to find a general condition for the existence of multiple resonant frequencies.

For this step current injection model, the following equation can be obtained:

$$\{ \begin{matrix}\frac{d {i}_{L}}{d t} = - \frac{R}{L} {i}_{L} - \frac{1}{L} {v}_{C} \\ \frac{d {v}_{C}}{d t} = \frac{1}{C} I + \frac{1}{C} {i}_{L}\end{matrix} \qquad ( 7 \text{-} 15 )$$

If the resonant voltage vC is considered, a second order ordinary differential equation can be obtained as:

$$LC \frac{{d}^{2} {v}_{C}}{d {t}^{2}} + RC \frac{d {v}_{C}}{d t} + {v}_{C} = IR \qquad ( 7 \text{-} 16 )$$

With the initial condition v_{c}(0)=0,

$${i}_{L} ( 0 ) = C \frac{d {v}_{C}}{d t} - I$$

the complete solution to the capacitor voltage can be easily obtained and expressed as:

$${v}_{c} ( t ) = \frac{IR}{sin θ} {e}^{- \frac{t}{τ}} sin ( {ω}_{f} t - θ ) + IR \qquad ( 7 \text{-} 17 )$$

where ω_{f}=2πf is the free ringing angular frequency, τ=2L/R is the time constant, and θ is an initial phase angle which can be expressed as:

$$θ = arctan ( \frac{{ω}_{f} IRC}{{i}_{L} ( 0 ) + I ( 1 - RC / T )} ) \qquad ( 7 \text{-} 18 )$$

It can be seen that the voltage equation consists of a forced DC offset component and a natural resonance with decay component. The competition between the DC offset and the decay will determine if the voltage has multiple ZVS points.

The ZVS period is determined by the circuit parameters L, C, R, the injection current and the initial track current. At each ZVS switching instant, the track current is lagging behind the capacitor voltage. The lagging current will offset the DC effect of the step injection current and contribute to more ZVS points. However, the initial current cannot be given arbitrarily, which is determined by operation conditions, e.g. input voltage and Q. A low input voltage with will cause a low current. At the switching transient, although the track current is around the negative peak, it can be close to zero if the input voltage is very small Under such a condition, if assuming the initial current in equation (7-17) is zero, the critical ZVS condition obtained for the circuit will be valid for different inputs, which will cause a higher negative initial value which partly offsets the DC effect of the step injection current. According to this, if assuming the initial track current is assuming as iL(0)=0, a minimum critical value of Q obtained is which ensures the existence condition of the ZVS points. Under such a condition, by considering the complete solution from equation (7-17), the minimum value of the resonant voltage can be obtained if its derivate is equal to zero as expressed by:

v′_{c}(t)=0 (7-19)

It can be derived that the time corresponding to the minimum and maximum voltage is:

$$t = \frac{1}{{ω}_{f}} ( arctan ( {ω}_{f} ) + π + θ ) \qquad ( 7 \text{-} 20 )$$

A meaningful “t” corresponds to a minimal resonant voltage, and there may be more than one of these points. Substituting equation (7-20) into the equation (7-17), all the minimum or the maximum voltages can be expressed as:

$${v}_{C} = - IRQ {e}^{- \frac{t}{τ}} + IR \qquad ( 7 \text{-} 21 )$$

The minimum or the maximum resonant voltage is related to the quality factor of the tuning circuit, the injection current, and the total equivalent load resistance. For the existence of the n^{th} zero voltage crossing, the corresponding v_{Cmin} in the next negative half cycle will have to be smaller than or equal to zero and should meet the following condition:

$$Q {e}^{- \frac{{t}_{min}}{τ }} \geq 1 \qquad ( 7 \text{-} 22 )$$

Here tₘᵢₙ varies for different zero points. It occurs at approximately at ((4n−1)π/2ω₀), where n is integer. For example, it is 3π/2ω₀ for the 1^{st} operation point and 7π/2ω₀ for the 3^{rd} operation point. Because τ=2Q/ω₀, equation (7-22) therefore can be solved for each operation point. The critical Q can be obtained to ensure the existence of ZVS points. Equation (7-22) therefore can be expressed for different operation points as:

$$Q ln Q \geq \frac{( 4 n - 1 )}{4} π \qquad ( 7 \text{-} 23 )$$

It is easy to get the numerical solution to different ZVS operation points. For example, if the inverter is to operate at the 3^{rd} ZVS point, the circuit has to be designed to have Q>3.98 to ensure resonance. Similarly, if it is operating at the 5^{th} ZVS point, Q should be larger than 5.23.

Simulation and Experimental Results

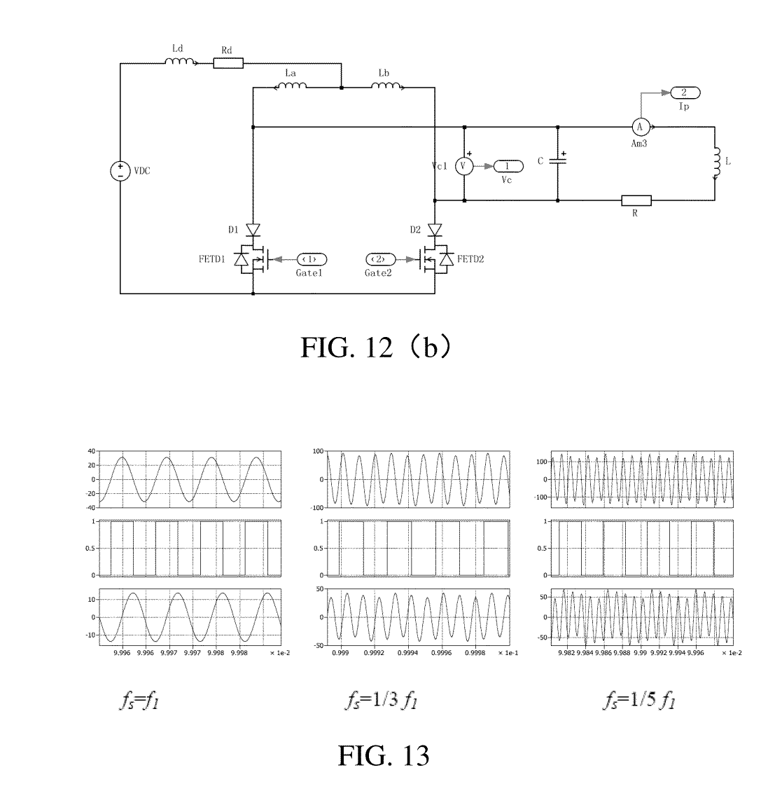

To investigate the operation of the push pull inverter in the proposed boost mode operation, a simulation study is undertaken using Simulink/PLECS. The PLECS model of the push pull inverter is shown in FIG. 12 (a). The gate drive signal is generated according to the different ZVS periods which were obtained using the stroboscopic mapping method discussed earlier. The diagram of the push pull inverter is shown in FIG. 12 (b). It consists of two MOSFETs and two blocking diodes in series connection to prevent possible shorting of the resonant capacitor by reversing conduction of the two MOSFETs. The detailed circuit parameters are listed in Table 1.

The multiple odd ZVS points obtained previously are listed in Table 2. The simulation study takes the 3rd and 5th operation points as examples to evaluate the operation and performance. For comparison, simulation at the fundamental ZVS point is also undertaken. The simulation waveforms of the resonant voltage and the track current are shown in FIG. 13.

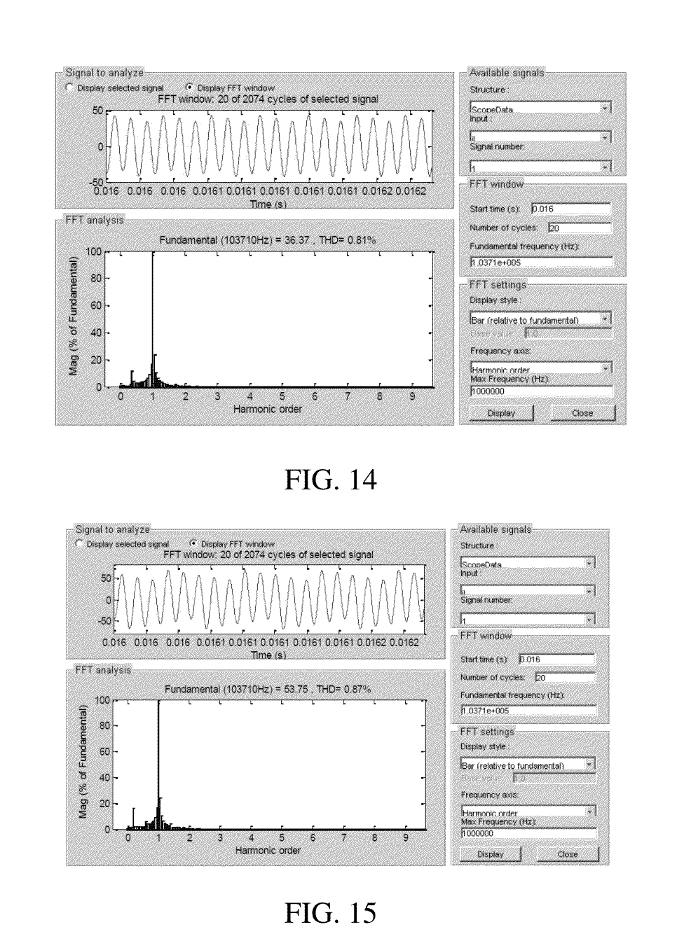

It can be seen that as expected from earlier analysis the resonant voltage is boosted by about three and five times compared to the fundamental ZVS operation point when operation is at a third or a fifth of the frequency of the fundamental respectively. The track current is boosted accordingly. But it can also be seen from the simulation result that the boosted current has some ripple, which is mainly caused by the DC offset and the circuit decay. Using the Powergui FFT analysis tool within Matlab/Simulink, FFT analysis of resonant current has been undertaken and results are shown in FIG. 14 and FIG. 15 respectively. Although the current amplitude fluctuates, the waveform is smooth and nearly sinusoidal. The overall THD is 0.81% and 0.87% at the 3^{rd} and 5^{th} ZVS operation point respectively. This is sufficiently good for IPT applications, where the average power transfer is the major interest.

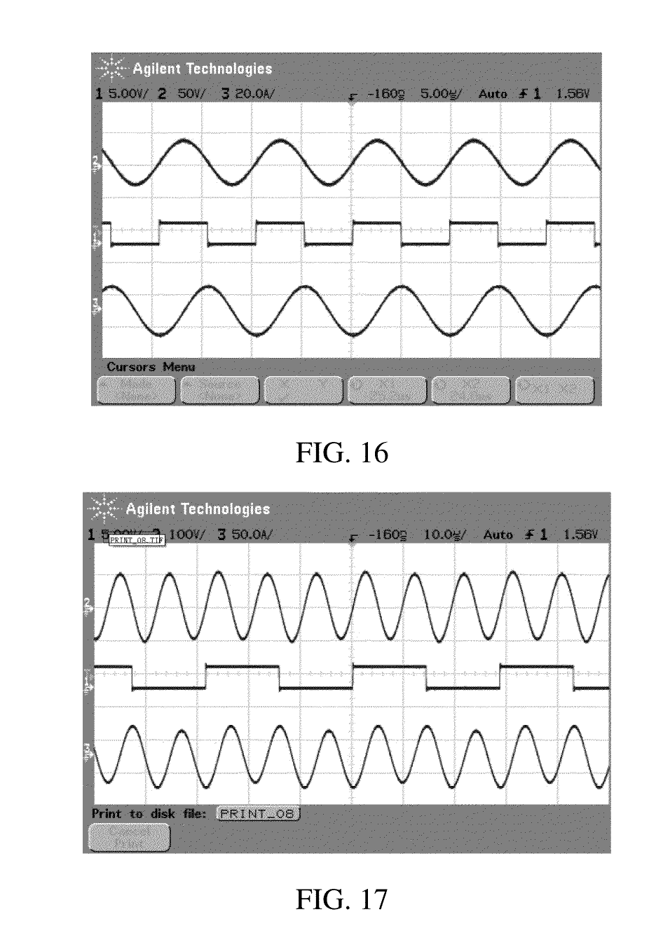

An experimental system has also been set up using the same circuit as in the simulation study. The Q of the circuit is 36, which is much higher than the theoretical values of 3.98 and 5.23 to ensuring the existence of the 3^{rd} and the 5^{th} ZVS operation points. As shown in the FIG. 16 to FIG. 18, the experiment has demonstrated these two points do exist, and the inverter is operated at the fundamental, and the 3^{rd} and 5^{th} ZVS operation periods. The experimental results of the gate drive signal, the resonant voltage, and the resultant track current are also shown. From top to bottom, the waveforms are the resonant voltage of the capacitor (trace 2), the gate signal of S1 (trace 1), and the track current (trace 3).

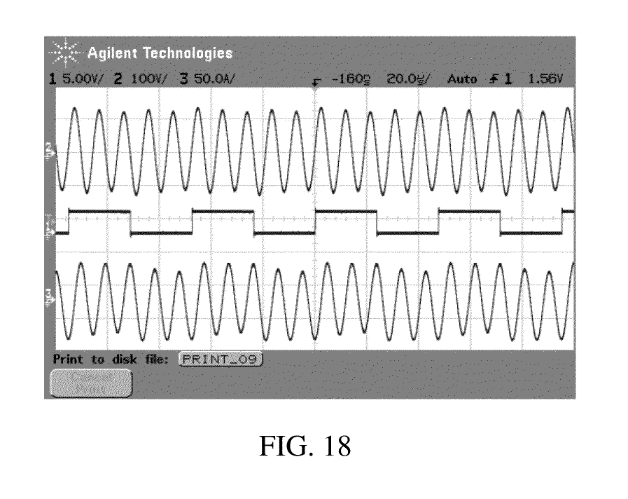

It can be observed that the push pull inverter results in different resonant voltages and tracks current when operated at these different ZVS switching frequencies. These experimental results are very close to simulation results shown in FIG. 13. The peak value of the resonant voltage in FIG. 17 is about 100V, which is nearly three times over the voltage at the first points shown in FIG. 16. Accordingly, the voltage in FIG. 18 is about five times higher. The track current has also been increased by operating at different frequencies, which is also nearly three and five times higher by operating at the 3^{rd} and 5^{th} operation point. As shown, the track current fluctuations are clearly observable when the push pull inverter operates at the boost mode, but the track current waveform obtained is sufficiently good for IPT applications where the key interest is high frequency magnetic field generation for average energy transfer.

In summary, a method of operating a traditional push pull inverter in the boost mode has been proposed. The principle of this boost operation was discussed. It has been found that operating over a long period operation leads to a boost in both the resonant voltage and track current of a push pull configuration for IPT systems. To achieve ZVS operation, different zero voltage crossing points have been found using a stroboscopic mapping model. The boost ability and quality of the voltage and current at different ZVS operation frequencies were analyzed. As shown the traditional push pull inverter should be operated at one of the ZVS operation points to ensure high quality while boosting can boost the resonant voltage and track current.

From a system design point of view, the conditions of the existence of different ZVS points of a push pull inverter were analyzed. The minimum critical Q was defined for different ZVS operation points, which is important for designing a push pull inverter with boost operation.

In order to verify the boost operation, a simulation study was undertaken. A practical push pull inverter was built and tested. Both the simulation and practical results demonstrated that push pull inverter can operate under boost mode at lower ZVS frequencies, which offers a good choice of operating a traditional push pull inverter for high power IPT applications.

The above elaborates the push pull inverter of the present invention, which is used to help to understand the present invention, but implementation manners of the present invention are not limited to the above embodiments. Any variation, modification, replacement, combination and simplification made without departing from the principle of the present invention should be equivalent substitution manners, and should be included in the protection scope of the present invention.

What is claimed is:

1. A push pull inverter, comprising a DC source V_{DC}, an inductor Lₐ and an inductor L_{b}, wherein a first end of the inductor Lₐ is connected with a first end of the inductor L_{b}, an anode of the DC source V_{DC} is connected to the first ends of the inductor Lₐ and the inductor L_{b} through an inductor L_{d} and a resistor R_{d} sequentially connected in series, a voltage of a second end of the inductor Lₐ is loaded to a drain of a switching tube S₁, a voltage of a second end of the inductor L_{b} is loaded to a drain of a switching tube S₂, a source of the switching tube S₁ and a source of the switching tube S₂ are connected to a cathode of the DC source V_{DC}, two signals which are at the same frequency but opposite in phase are respectively connected to a gate of the switching tube S₁ and a gate of the switching tube S₂, and a resonant circuit (10) is connected between the second end of the inductor Lₐ and the second end of the inductor L_{b}.

2. The push pull inverter according to claim 1, wherein the resonant circuit (10) is a parallel resonant circuit.

3. The push pull inverter according to claim 2, wherein the resonant circuit (10) comprises a capacitor C₁, an inductor L₁ and a resistor R₁, two ends of the capacitor C₁ are respectively connected with the second end of the inductor Lₐ and the second end of the inductor L_{b}, and the inductor L₁ is connected in series to the resistor R₁ and then connected in parallel to the capacitor C₁.

4. The push pull inverter according to claim 1, further comprising a diode D₁, an anode of the diode D₁ being connected with the second end of the inductor Lₐ, and a cathode of the diode D₁ being connected with the drain of the switching tube S₁.

5. The push pull inverter according to claim 1, further comprising a diode D₂, an anode of the diode D₂ being connected with the second end of the inductor L_{b}, and a cathode of the diode D₂ being connected with the drain of the switching tube S₂.

6. The push pull inverter according to claim 1, wherein a frequency generated by the resonant circuit (10) is odd times of switching frequencies generated by the switching tube S₁ and the switching tube S₂.
